(19) United States
(12) Patent Application Publication
(10) Pub. No.: US 2017/0342312 A1
(43) Pub. Date: Nov. 30, 2017

(54) COMPOSITION AND METHOD FOR VISCOSITY CONTROL IN DELIVERY APPLICATIONS USING SUBSEA UMBILICALS

(71) Applicant: BAKER HUGHES, A GE COMPANY, LLC, Houston, TX (US)

(72) Inventor: CARLOS MANUEL MENENDEZ, HOUSTON, TX (US)

(73) Assignee: BAKER HUGHES, A GE COMPANY, LLC, Houston, TX (US)

(21) Appl. No.: 15/680,000

(22) Filed: Aug. 17, 2017

Related U.S. Application Data
(62) Division of application No. 15/135,829, filed on Apr. 22, 2016.

(51) Int. Cl. C09K 8/54; C10L 3/10; C10G 75/02; F16L 58/00

(52) U.S. Cl. CPC C09K 8/54; F16L 58/00; C10L 3/107; C10G 75/02; C09K 2208/32; C10L 2290/24

(57) ABSTRACT

A treatment composition for use in treating production fluids in or from a subterranean formation is provided. The treatment composition can be used for viscosity control in subsea umbilical fluid delivery applications, wherein the treatment composition exhibits desirable viscosity, flash point and/or pour point values.

### RELATED APPLICATIONS

This application is a divisional application and claims the benefit, and priority benefit, of U.S. application Ser. No. 15/135,829, filed Apr. 22, 2016, the disclosure and contents of which are incorporated by reference herein in its entirety.

### BACKGROUND

### Field of the Invention

In the oil and gas industry, a production well can be utilized to extract hydrocarbon-containing production fluids such as crude oil or natural gas from a subterranean formation.

It is sometimes desirable to inject one or more fluid additives into the production well or its related piping (such as hydrate inhibitors, corrosion inhibitors, scale inhibitors and the like) to improve the well or piping environment and enhance production. Accordingly, the production well can have associated equipment for introducing the one or more additives into the production fluid at a subsea location.

The equipment can often include an umbilical line that is connected, for example, on one end to a drilling platform and on another end to the production well or to a pipeline manifold. The umbilical line can include a plurality of electrical conduits and a plurality of fluid conduits formed into a bundle, and a plurality of protective layers surrounding the bundle. The electrical conduits can carry power from the platform to the production well and/or the manifold and the fluid conduits can be used as chemical injection piping to deliver the fluid additives into the production well and/or the manifold.

In some instances, the umbilical line must be located at a distance that is substantially below the surface of the sea or the sea floor, which poses challenges for the user. For example, it is difficult to formulate an additive that has a high flash point (>60° C.) and a desired viscosity for injection through subsea umbilicals. It is known in the art to mix the additives with solvents such as water, alcohol, monoethylene glycol or propylene glycol to try and control and adjust flash point and viscosity properties. However, the flash point requirements of alcohols like methanol, isopropyl alcohol, and n-butanol are too low to be effective. Combinations of water and monoethylene glycol with certain other solvents have also been attempted, but the use of monoethylene glycol is inconvenient because of its relatively high viscosity (17 cP at 20° C.). Further, the amount of monoethylene glycol needs to be greater than water percent wise to make the product hydrate proof for umbilical use.

Improvements in this field of technology are therefore desired.

### SUMMARY

Various illustrative embodiments of a treatment composition for a production fluid in an oil and gas pipeline are provided herein. In certain aspects, the treatment composition can include at least one treatment chemical and a solvent comprising ethylene glycol n-butyl ether acetate. The at least one treatment chemical can include a corrosion inhibitor. The production fluid can be one or more of crude oil and natural gas.

Various illustrative embodiments of a treatment composition for a production fluid from an oil and gas well are also provided herein. In certain aspects, the treatment composition can include at least one treatment chemical and a solvent having a flash point of 60° C. or greater and a viscosity of 1.81 cP or lower at 20° C. and 1 bar. The at least one treatment chemical can include a corrosion inhibitor.

Various illustrative embodiments of a method of treating a production fluid in an oil and gas pipeline are also provided herein. In certain aspects, a treatment composition can be introduced into the production fluid. The treatment composition can include at least one treatment chemical and a solvent comprising ethylene glycol n-butyl ether acetate. The at least one treatment chemical can include a corrosion inhibitor. The production fluid can be one or more of crude oil and natural gas.

Various illustrative embodiments of a method of preventing or mitigating the formation of hydrates in a pipeline for delivering a treatment chemical to an oil and gas well are also provided herein. In certain aspects, ethylene glycol n-butyl ether acetate can be introduced into the treatment chemical. In certain aspects, ethylene glycol n-butyl ether acetate can be mixed with the treatment chemical. The pipeline can be a subsea umbilical pipeline. The at least one treatment chemical can be a corrosion inhibitor. The production fluid can be one or more of crude oil and natural gas.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter. Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

### DETAILED DESCRIPTION

Disclosed herein are various illustrative embodiments of a treatment composition for use in treating production fluids in or from subterranean formations. In certain illustrative embodiments, the treatment composition can be used for viscosity control in subsea umbilical fluid delivery applications, wherein the treatment composition exhibits desirable viscosity, flash point and/or pour point values as compared to prior art compositions.

In certain illustrative embodiments, a treatment composition for a production fluid in a pipeline associated with an oil and gas well is provided. The treatment composition can include at least one treatment chemical and a solvent. Preferably, the solvent has a flash point of 60° C. or greater and a viscosity of 1.81 cP or lower at 20° C. and 1 bar.

In certain illustrative embodiments, a method of treating a production fluid in a pipeline associated with an oil and gas well is also provided wherein the treatment composition is introduced into the production fluid.

In certain illustrative embodiments, a method of preventing or mitigating the formation of hydrates in a pipeline for delivering one or more treatment chemicals to an oil and gas well is also provided wherein a solvent comprising ethylene glycol n-butyl ether acetate solvent is mixed with the treatment chemical(s) and injected into the pipeline and/or the production fluid in the pipeline. Hydrates are formed at low temperature and high pressure in formation fluids or natural gases in connection with water present in the system. The hydrates usually exist in solid form and are detrimental to handling and transport of the production fluids. In certain illustrative embodiments, the prevention of hydrates is achieved by avoiding the presence of water in the formulation. If water is present in the formulation, then thermodynamic hydrate inhibitors like monoethylene glycol or propylene glycol can also be utilized at a ratio of about 1 volume of inhibitor to 1 volume of water, in certain illustrative embodiments.

In certain illustrative embodiments, the pipeline of the various illustrative embodiments described herein can be a subsea umbilical line and/or its related piping, including manifolds and the like.

In certain illustrative embodiments, the treatment chemical can be an additive such as a hydrate inhibitor, a corrosion inhibitor, a paraffin inhibitor, a scale inhibitor, a biocide, a demulsifer, a hydrogen sulfide scavenger, an oxygen scavenger, a water treatment, and an asphaltene inhibitor. Preferable, the treatment chemical is a corrosion inhibitor that is chemically stable in the low viscosity and high flash point solvent package.

In certain illustrative embodiments, the solvent can be ethylene glycol n-butyl ether acetate. Ethylene glycol n-butyl ether acetate is a high boiling, slow evaporating ester solvent that is miscible with alcohols and ketones. It has the chemical formula C₈H₁₆O₃ or C₄H₉OCH₂CH₂OC(O)CH₃ and the following structure:

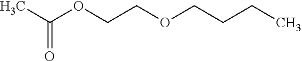

Ethylene glycol n-butyl ether acetate is commercially available from Dow Chemical Company under the trademark Butyl Cellosolve™ Acetate Solvent.

In certain illustrative embodiments, the ethylene glycol n-butyl ether acetate solvent can be utilized to adjust or “fine tune” the viscosity of candidate formulations for a treatment composition for use in subsea umbilical applications. For example, for certain subsea umbilical applications the solvent is desired to have a high flash point (>60° C.), a low pour point (<−20° C.) and a viscosity that is comparable to traditional solvents like methanol and isopropanol. Ethylene glycol n-butyl ether acetate solvent has been found to have these desirable properties.

In certain illustrative embodiments, ethylene glycol n-butyl ether acetate solvent has a viscosity of 1.79 cP at 20° C. while exhibiting a relatively high flash point of about 78° C. and a relatively low freezing point of about −64° C. Thus, ethylene glycol n-butyl ether acetate solvent, either alone or used in combination with ethylene glycol monobutyl ether (Butyl Cellosolve™, commercially available from Dow Chemical Company), can be used as an agent for viscosity control in situations where combinations such as water and monoethylene glycol or water and Butyl Cellosolve™ alone are insufficient to keep viscosity within range while maintaining a high content of actives and a low pour point for umbilical use in subsea injections.

In certain illustrative embodiments, ethylene glycol n-butyl ether acetate solvent is compatible with corrosion inhibitors without affecting their performance and has a friendly environmental profile which enables its use in subsea applications in the North Sea, Norway and West Africa. For example, the solvent according to its MSDS has environmental impact characteristics that make it a good candidate for a successful CEFAS registration. It is 77-90% biodegradable in seawater, the Log Pow bioaccumulation potential is less than 3 and the bioconcentration factor (BCF) is less than 100. Also, the toxicity is low since LC50 for fish, EC50 for invertebrates and EbC50 for algae are all >10 mg/L.

Table 1 (shown below) provides a comparison of various properties of ethylene glycol n-butyl ether acetate solvent compared to traditional solvents.

TABLE 1

| | | Flash | Freezing |
|---|---|---|---|
| | Viscosity | Point | Point |
| Solvent | (cP at 20° C./1 Bar) | (° C.) | (° C.) |
| Water | 0.895 | N.A. | 0 |
| Methanol | 0.59 | 12 | −97.8 |
| Isopropanol | 2.1 | 14 | −89.0 |
| Monoethylene Glycol | 17.3 | 116 | −13.0 |
| Propylene Glycol | 55.0 | 99.0 | −59.0 |
| Butyl Cellosolve ™ | 2.9 | 67.0 | −75.0 |
| Ethylene Glycol N-Butyl | 1.81 | 78 | −64.0 |
| Ether Acetate (aka Butyl | | | |
| Cellosolve ™ Acetate) | | | |

As shown above, methanol has a low viscosity and freezing point but its flash point is not acceptable for the uses described herein. Water has a low viscosity but its freezing point is very high. Isopropanol has a similar flash point and freezing point as methanol. Monoethylene glycol has a suitable flash point but its viscosity is thirty times larger than that of methanol. Propylene glycol has very attractive flash and freezing points but its viscosity is three times larger than that of monoethylene glycol. Butyl Cellosolve™ has suitable values for viscosity, flash point and freezing point, but its viscosity of 2.9 cP is not low enough for use in subsea umbilical applications.

By comparison, ethylene glycol n-butyl ether acetate solvent has a viscosity of 1.81 cP which is comparable to the value of 2.1 cP for isopropanol. Ethylene glycol n-butyl ether acetate solvent also features suitable flash and freezing point of about 78° C. and about −64° C., respectively.

Generally, products to be injected via umbilicals require a high pressure and low temperature viscosity lower than 100 cP. However, the proposed use that was targeted for certain of the presently described embodiments requires viscosity to be in the 65 to 80 cP range. In certain illustrative embodiments, the ethylene glycol n-butyl ether acetate solvent is part of the chemical composition of the product being delivered through the umbilical and the product is a liquid with a very specific viscosity requirement, generally less than 100 cP at 10,000 psi/4° C.

The treatment compositions described herein can also be used in applications beyond subsea injection of chemicals with umbilicals. For example, the treatment compositions described herein can be utilized in any circumstances where a relatively high flash point, low viscosity and low pour point as provided by ethylene glycol n-butyl ether acetate solvent are desired.

To facilitate a better understanding of the presently disclosed subject matter, the following examples of certain aspects of certain embodiments are given. In no way should the following examples be read to limit, or define, the scope of the presently disclosed subject matter.

Experimental Results

Table 2 demonstrates how ethylene glycol n-butyl ether acetate solvent is beneficial for bringing viscosity down to desired values. The corrosion rates shown in Table 2 were obtained using autoclave tests at 80° C., a partial pressure of CO₂ of 0.75 bar, a brine/hydrocarbon ratio of 99 to 1 and a shear stress of 60 Pa.

TABLE 2

| Components | Formulation I | Formulation II |
|---|---|---|
| Corrosion Actives (%) | 45.27 | 45.27 |
| Butyl Cellosolve ™ (%) | 54.23 | 27.12 |
| Ethylene Glycol N-Butyl | 0.0 | 27.11 |
| Ether Acetate (aka Butyl | | |
| Cellosolve ™ Acetate) (%) | | |
| Corrosion rate (mpy) | 3.1 | 6.2 |
| Viscosity (10K psi/4° C.) | 92.06 | 75.6 |

A prophetic model was prepared for predicting viscosity based on historical viscosity data. A matrix consisting of 35 corrosion inhibitor formulations containing a total of 14 different components which included corrosion inhibitor actives and solvents was analyzed using Design Expert Software.

In Table 3, the predicted viscosity data is provided to illustrate the effect of the addition of ethylene glycol n-butyl ether acetate solvent to the formulations.

TABLE 3

| Components (%) | Formulation III | Formulation IV | Formulation V |
|---|---|---|---|
| Imidazoline | 37.0 | 31.86 | 31.86 |
| Sulfur compound | 12.0 | 6.0 | 6.0 |
| Quaternized Amine | 0.0 | 10.00 | 10.00 |
| Acetic acid | 5.0 | 5.0 | 5.0 |
| Butyl Cellosolve ™ | 46.0 | 47.14 | 0.00 |
| Ethylene Glycol N-Butyl | 0.0 | 0.0 | 47.14 |
| Ether Acetate (aka Butyl | | | |
| Cellosolve ™ Acetate) | | | |
| Total | 100 | 100 | 100 |
| Corrosion rate (mpy) | 6.1 | — | 10.3 |
| Predicted viscosity | 91.9 | 153.8 | 94.7 |
| (10K psi/4° C.) | | | |

Table 3 shows that the addition of a quaternized amine to Formulation III to obtain Formulation IV led to an increase in viscosity from 91.9 to 153.8 cP despite of the reduction of imidazoline and sulfur compound contents, but when the Butyl Cellosolve™ was replaced with the same amount of ethylene glycol n-butyl ether acetate solvent, the viscosity was reduced to 94.7 cP which is just less than 100 cP.

The corrosion values obtained in Tables 2 and 3 illustrate that the use of ethylene glycol n-butyl ether acetate solvent did not significantly affect the performance of the corrosion inhibitors.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter.

Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

What is claimed is:

1. A method of treating a production fluid in an oil and gas pipeline, the method comprising: introducing a treatment composition comprising at least one treatment chemical and a solvent comprising ethylene glycol n-butyl ether acetate into a subsea umbilical line; and delivering the treatment composition to the production fluid via the subsea umbilical line.

2. The method of claim 1, wherein the at least one treatment chemical comprises a corrosion inhibitor.

3. The method of claim 5, wherein the production fluid comprises one or more of crude oil and natural gas.

4. A method of preventing or mitigating the formation of hydrates in a pipeline for delivering a treatment chemical to an oil and gas well, the method comprising: mixing ethylene glycol n-butyl ether acetate with the treatment chemical; and delivering the treatment composition to the production fluid via a subsea umbilical line.

5. The method of claim 4, wherein the treatment composition is delivered to the production fluid via a subsea umbilical line.

6. The method of claim 4, wherein the at least one treatment chemical comprises a corrosion inhibitor.

7. The method of claim 4, wherein the production fluid comprises one or more of crude oil and natural gas.

8. A method of treating a production fluid in an oil and gas pipeline, the method comprising: introducing a treatment composition into a subsea umbilical line; and delivering the treatment composition to the production fluid via the subsea umbilical line, wherein the treatment composition comprises at least one treatment chemical and a solvent having a flash point of 60° C. or greater and a viscosity of 1.81 cP or lower at 20° C. and 1 bar.

9. The method of claim 8, wherein the at least one treatment chemical comprises a corrosion inhibitor.

10. The method of claim 8, wherein the production fluid comprises one or more of crude oil and natural gas.
